(19) United States
(12) Patent Application Publication
(10) Pub. No.: US 2012/0018968 A1
(43) Pub. Date: Jan. 26, 2012

(54) SCOOTER AND METHOD OF USE THEREOF

(75) Inventors: Nick Joslin, Fleet (GB); Seth Bishop, Winchester (GB); Steve Moore, London (GB)

(73) Assignee: RE:CREATION GROUP PLC, Finchampstead (GB)

(21) Appl. No.: 12/994,041

(22) PCT Filed: May 22, 2009
(86) PCT No.: PCT/GB2009/001299

§ 371 Date: Mar. 3, 2011

(30) Foreign Application Priority Data
May 22, 2008 (GB) 0809278.5

(51) Int. Cl. B62M 1/00

(52) U.S. Cl. 280/87.041

(57) ABSTRACT

A scooter (102) is provided comprising a plurality of components including at least support means for supporting at least part of a user thereon in use, scooter movement means associated with said support means for allowing the support means to move across a surface in use and handle means for allowing a user to hold onto the scooter in use. One or more of the components are provided with means to allow the component or a part of said component to move relative to another component or other part of said component between a first substantially erect condition and at least a second partially or substantially folded or collapsed condition.

This invention relates to a scooter and method of use thereof.

Although the following description refers almost exclusively to a scooter of a type propelled manually by a user, such as for example by a user balancing on the scooter using one foot and propelling the scooter in a required direction by pushing off from a floor surface using their other foot, it will be appreciated by persons skilled in the art that the scooter could include a powered, motor driven scooter and/or any other type of driven scooter.

Manually driven scooters have been used for many years, particularly by children, as a means for transport and/or as toy apparatus. A conventional manually driven scooter typically includes an elongate foot plate with one or more wheels located at each end of a base of the foot plate. An upright steering column is provided at a front end of the foot plate and handles are provided at a top of the upright steering column to allow a user to grip and steer the scooter. In use, a user typically grips hold of the handles using their hands and uses one foot to balance on the foot plate. The user's other foot is used to propel the scooter across a floor surface.

A problem with conventional scooters is that they take up a large amount of space and are not easily transportable when not in use.

It is therefore an aim of the present invention to provide a scooter which overcomes the abovementioned problems.

It is a further aim of the present invention to provide a method of using a scooter which overcomes the above-mentioned problems.

According to a first aspect of the present invention there is provided a scooter, said scooter comprising a plurality of components including at least support means for supporting at least part of a user thereon in use, scooter movement means associated with said support means for allowing the support means to move across a surface in use and handle means for allowing a user to hold onto the scooter in use, and wherein one or more of said components are provided with means to allow the component or a part of said component to move relative to another component or other part of said component between a first substantially erect condition and at least a second partially or substantially folded or collapsed condition.

By allowing a component or part of a component to be moved between erect and at least partially folded conditions, this allows the scooter to be folded or collapsed to reduce the size of the scooter, thereby making the scooter easier to transport and/or store when not in use. The “erect” condition typically corresponds to the “in-use” position and the “folded” or “collapsed” condition typically corresponds to an out-of-use position or storage position.

The component movement means by which a component or part of a component can be moved relative to another component or other part of said component between said first and second conditions can include any or any combination of one or more pivotable, rotatable, telescopic and/or slidable joints, points or mechanisms. The joints used to provide this movement can include any or any combination of one or more pivot joints, hinge, swivel joint, ball and socket joint and/or the like.

In one embodiment locking means can be provided to lock the component or component part in the first and/or second condition to maintain the same in said condition until the locking means is moved to an unlocked position.

The scooter can be a manually driven scooter, a powered scooter driven by suitable power means or a motor driven scooter.

Preferably the movement means (scooter movement means) includes one or more wheels, tracks, rollers, balls, ball bearings and/or the like.

Preferably the scooter movement means are provided at or adjacent each end of the support means, such as for example at a front and rear end of the support means or opposite ends of the support means, and are arranged so as to contact a ground surface in use over which the scooter is to be moved in use.

In a preferred embodiment the support means includes a foot plate. A user typically uses one or both of their feet to stand on an upper surface of the foot plate in use. However, it will be appreciated that the support means could include seating means and/or the like to allow a user to sit or support them on the scooter in a suitable manner in addition to or as an alternative to said foot plate.

Preferably the handle means includes an upright member associated with the support means and/or movement means and gripping means are associated with said upright member, and preferably an upper part of said upright member, to allow a user to grip onto the same in use. In one embodiment two gripping means are preferably provided, one on either side of the upright member and preferably substantially perpendicular to said upright member. Said gripping means can include at least one protruding arm protruding substantially perpendicular to said upright member.

The handle means, upright member and/or gripping means can be used to aid steering of the scooter in use. Further preferably the handle means or upright member is typically provided adjacent a front of the scooter.

In one embodiment the handle means or upright member is joined to a wheel or scooter movement means at a front of the scooter.

Any or any combination of other components can be provided on the scooter if required, such as braking means to allow a user to stop the scooter in use; guards for the scooter movement means, such as wheel guards to limit spray from the movement means on wet ground; illumination means, such as a light to allow a user to see where they are going on the scooter or to allow third parties to see the user on the scooter; luggage carrying means, such as a basket, container, recess and/or the like to allow an item of luggage or one or more objects to be transported on the scooter; one or more signalling means, such as a bell or horn to allow a user to inform third parties of their whereabouts and/or the like.

The support means can be pivotably or rotatably mounted, directly or indirectly, to the handle means to allow the handle means to be moved relative to the support means to help steer the scooter. In one embodiment the handle means are typically rotatable or pivotable about an upright axis or an axis substantially parallel to the longitudinal axis of the handle means to allow steering of the scooter via the handle means.

In accordance with the present invention, in one embodiment the handle means can be moved between an erect condition and at least a partially collapsed or folded condition.

In one embodiment the support means can be moved between an erect condition and at least a partially collapsed or folded condition.

Preferably a plurality of scooter movement means are provided and said movement means are arranged such that they can be moved substantially simultaneously between an in-use position or erect position, to an out-of-use or at least partially folded position.

Preferably movement of the scooter movement means between the in-use and out-of-use positions, releases or allows the release of a locking mechanism to allow the support means to be moved between an erect position and at least a partially collapsed or folded position. The locking mechanism is preferably released automatically without direct or further user intervention.

In one embodiment the scooter movement means and handle means are joined by connection or linkage means and arranged such that movement of the scooter movement means between the erect and at least partially folded positions automatically moves or allows movement of the handle means between the erect and at least partially folded positions.

Preferably the handle means are rotatable or pivotable about a substantially horizontal axis or an axis substantially parallel to the longitudinal axis of the support means in moving between the first and second conditions. This allows the handle means to be moved to a partially folded position.

The upright member of the handle means preferably includes two or more parts and one or more of said parts are movable relative to one or more of said other parts to allow the length of the upright member to be adjusted. For example, the two or more parts can be telescopically mounted to allow movement between erect and collapsed positions; extended or retracted positions, foldably mounted via a hinge joint, double hinge joint and/or the like.

If the parts are telescopically mounted locking means can be provided to lock the parts at a required position so that the handle means are at a required length.

In a preferred embodiment a sleeve or cover member is slidably mounted on the upright member to act as a locking mechanism for a hinge joint provided between the parts of the upright member. With the sleeve member located over the hinge joint (i.e. in a locked position) the upright member parts are prevented from folding about the hinge joint. With the sleeve member moved a spaced distance apart from the hinge joint (i.e. in an unlocked position), the upright member parts can be folded relative to each other. The sleeve member provides rigidity to the hinge joint when in the locked position.

The sleeve member can be maintained in the locked or unlocked positions via locking means. In one example, the locking means includes a resiliently biased pin provided on one of the upright member parts or sleeve member which is located in an aperture provided in the other of the upright member parts or sleeve member in the locked position. In the unlocked position, the pin is pushed inwardly of the part to allow release from said aperture, thereby allowing the sleeve member to be slidably moved over said upright member.

In one embodiment the locking means on the upright member includes a resiliently biased pin provided on one of the handle parts which is biased towards the opening of an aperture provided on the other of the handle parts.

In one embodiment the locking means associated with the sleeve member on the upright member has a screw thread which engages with a complementary screw thread on the upright member to maintain the sleeve member in a locked position until release of the sleeve member allows said member to be moved.

Preferably the two or more gripping means or portions are hingedly mounted to the handle means or upright members, either directly or indirectly, to allow the gripping portions to be moved between a substantially erect or first position, wherein the gripping means or portions are provided or a side or either side of the upright member in a co-axial arrangement and substantially perpendicular thereto, to a folded or second position, wherein the gripping means or portions are moved towards each other to a substantially parallel and adjacent position. The gripping portions are each typically moved through approximately 90 degrees in moving the same from the erect or first position to the folded or second position.

Preferably the support means or foot plate is formed from two or more parts and said parts are movavble relative to each other between a second or folded position and a first or erect position. In the erect position, the support mean parts are substantially co-planar to form an elongate platform. In the folded position, at least one of said support mean parts is moved through approximately 180 degrees so that said parts are substantially adjacent and parallel to each other.

Preferably the support mean parts are movable about an axis of rotation provided substantially transverse to the longitudinal axis of the support means. Preferably the parts are hinged substantially centrally of the support means.

Preferably the scooter movement means are rotatable about a substantially horizontal axis in a first condition and an axis substantially perpendicular to the first position axis of rotation of the movement means in the second condition.

In one embodiment a pivotable or rotatable arm is provided substantially along the length of and substantially parallel to the longitudinal axis of the support means. Preferably the arm is able to rotate or pivot about an axis substantially parallel to the longitudinal axis of the support means.

This arm can join, either directly or indirectly, the front and rear movement means of the scooter in one embodiment. As such, the movement means or wheels of the scooter can be moved substantially simultaneously from an erect position, wherein the rotational axis of the wheels is substantially horizontal, to a folded position, wherein the rotational axis of the wheels is substantially vertical. The handle means can be associated with the movement means, such that the handle means moves with the movement means on pivoting of the pivot arm associated with the support means.

Preferably the pivot arm is located adjacent a base of the support means or foot plate and is attached to the same via attachment means. The attachment means typically allows free rotation of the pivot arm and can include one or more brackets, clips, ties and/or the like.

In one embodiment the pivotable arm is provided with at least one locking mechanism. In one example the locking mechanism is provided adjacent the hinge means of the support means parts. With the scooter in the first in-use position, the axis of rotation of the locking mechanism of the pivot arm is substantially perpendicular to the axis of rotation of the hinge means. When the movement means of the scooter have been moved to a second out-of-use position or partially folded condition, this moves the locking mechanism on the pivot arm so that the axis of rotation of the locking mechanism is substantially parallel to the axis of rotation of the hinge means, thereby allowing the support mean parts to be moved to a second or folded condition.

In one example the locking mechanism includes a locking handle which is user actuated. The locking handle can be moved between a locked condition and an unlocked condition.

Preferably the locking means associated with the support means and/or the handle means to maintain the same in a substantially erect or first position is resiliently biased to a locked position. Further preferably the resiliently biasing means is in the form of a sprung loaded lock configuration and yet further preferably the spring loaded lock configuration is associated with the pivot arm of the support means.

In the second or fully folded condition, the longitudinal axes of the support means or foot plate parts and handle means or upright member parts are substantially parallel with each other, thereby providing a compact design. The gripping portions are typically provided adjacent each other at one end of the folded configuration. The gripping portions are preferably provided at the end adjacent both wheels in the second condition.

In moving the scooter from a folded condition to an erect condition, the reverse process to the folding process is typically undertaken.

The movable joints are typically formed in such a manner that a user is prevented from trapping their fingers and/or body parts therein.

Preferably the connection means has a clutched axle, toothed rotatable member and/or gear mechanism to allow controlled movement of the connection means relative to the support means in the unlocked position.

According to a second aspect of the present invention there is provided a method of using a scooter, said scooter comprising a plurality of components including at least support means for supporting at least part of a user thereon in use, scooter movement means associated with said support means for allowing the support means to move across a surface in use and handle means for allowing a user to hold onto the scooter in use, and wherein said method includes the step of moving one or more of said components or a part of said component relative to another component or other part of said component between a first substantially erect condition and at least a second partially or substantially folded or collapsed condition.

According to separate independent aspects of the present invention there is provided a method of using a scooter; a method of folding a scooter; and a foldable scooter.

According to a further aspect of the present invention there is provided a scooter, said scooter comprising a plurality of components including at least support means for supporting at least part of a user thereon, movement means associated with said support means for allowing the support means to move across a surface in use and handle means for allowing a user to hold onto the scooter in use, and wherein said movement means are movable between an in-use position wherein the movement means are capable of moving about a first axis, and an out-of-use position, wherein the movement means are capable of moving about a second axis which is substantially perpendicular to said first axis.

Preferably movement of the movement means between the in-use position to the out of use position allows the support means to be moved between an erect position and at least a partially folded position.

Preferably movement of the movement means between the in-use position to the out of use position causes the handle means to move through substantially the same angle and/or in the same direction.

According to a yet further aspect of the present invention there is provided a scooter, said scooter comprising a plurality of components including at least support means for supporting at least part of a user thereon, movement means associated with said support means for allowing the support means to move across a surface in use and handle means for allowing a user to hold onto the scooter in use, and wherein said handle means include at least two parts which are hingedly or pivotably joined together and a sleeve member is movable relative to said hinge or pivot joint to move the joint between a locked position, wherein the two handle means parts remain in an erect position, to an unlocked position, wherein the two handle means parts are capable of being moved to a folded position.

Embodiments of the present invention will now be described with reference to the accompanying figures, wherein:

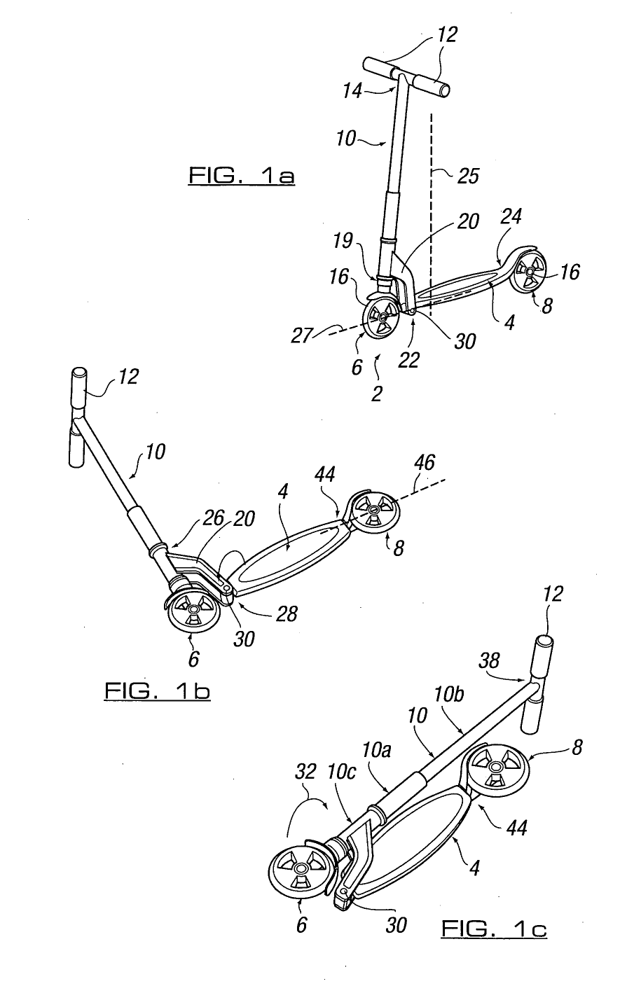

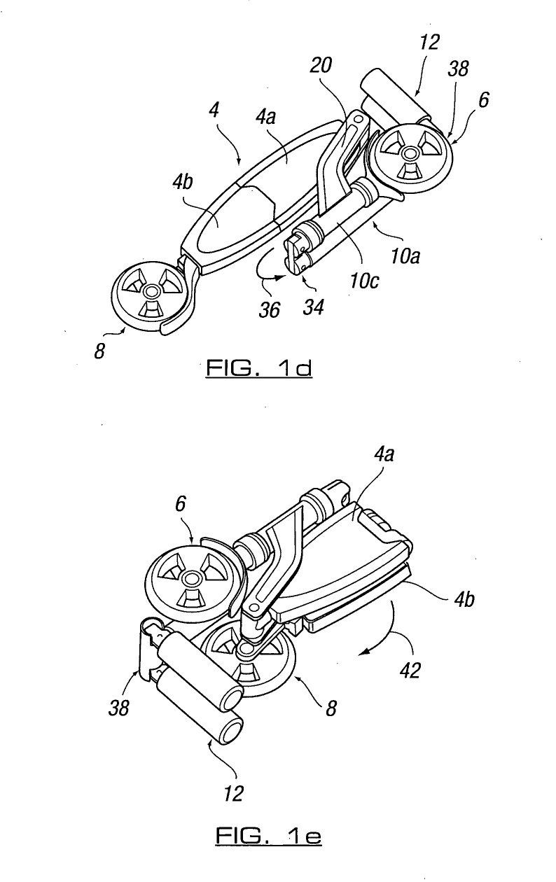

FIGS. 1a-1e illustrate a front view of a scooter according to an embodiment of the present invention showing different stages of the scooter being moved between a fully erect condition in FIG. 1a to a collapsed condition in FIG. 1e;

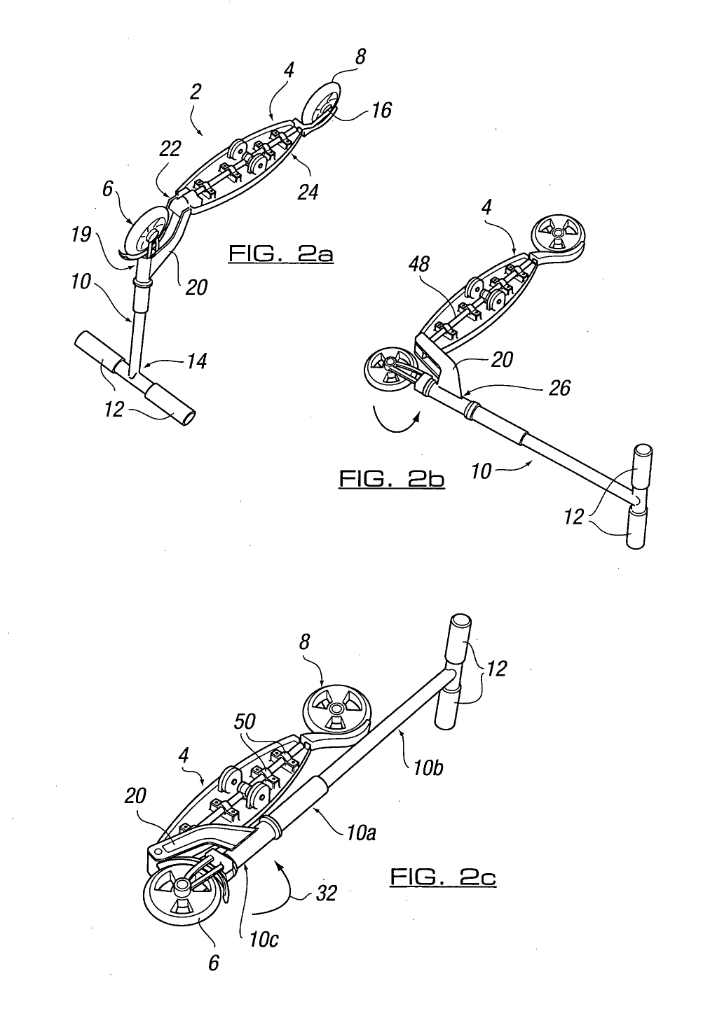

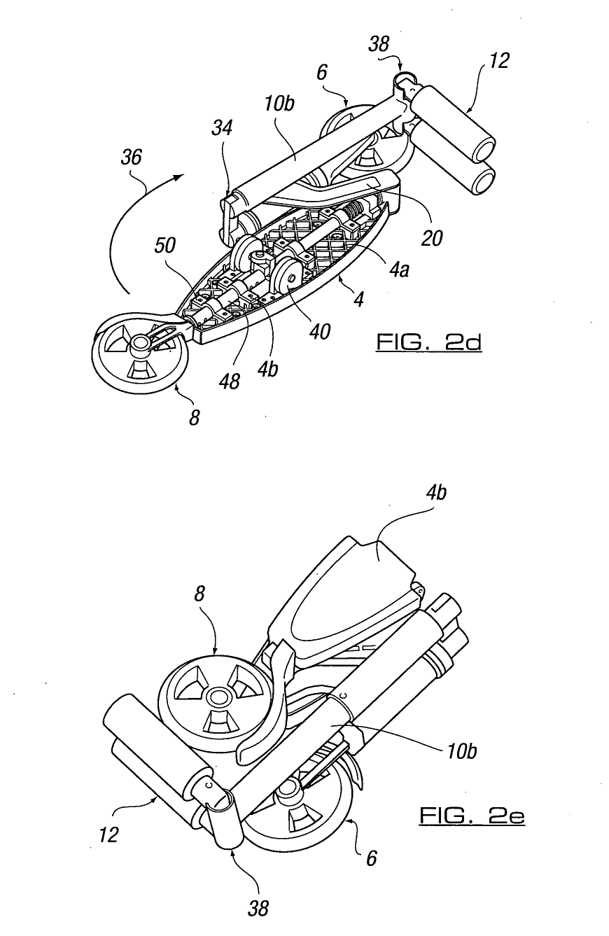

FIGS. 2a-2e illustrate a base view of the scooter in FIGS. 1a-1e respectively;

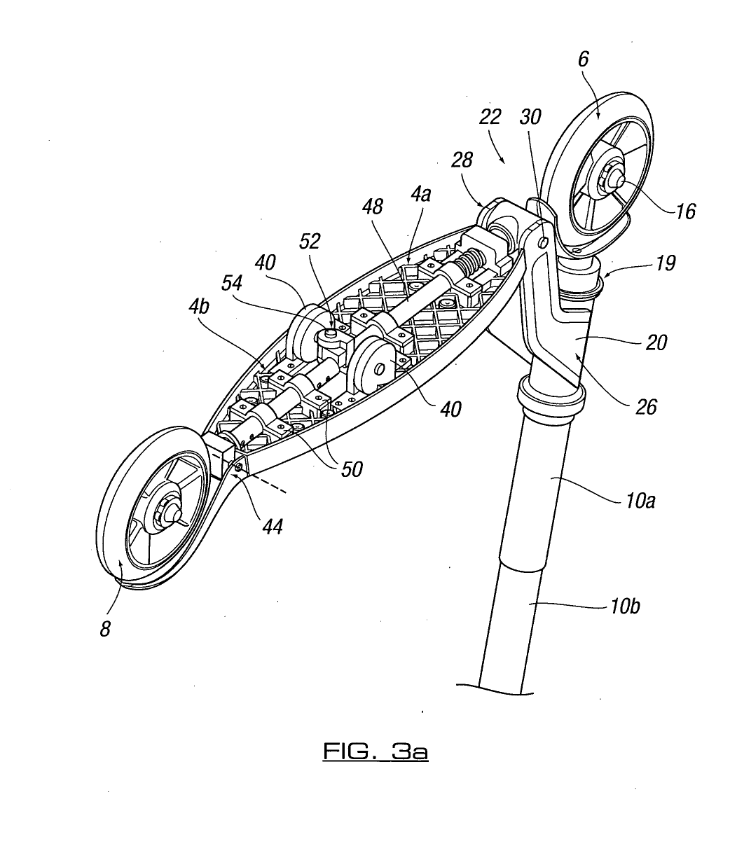

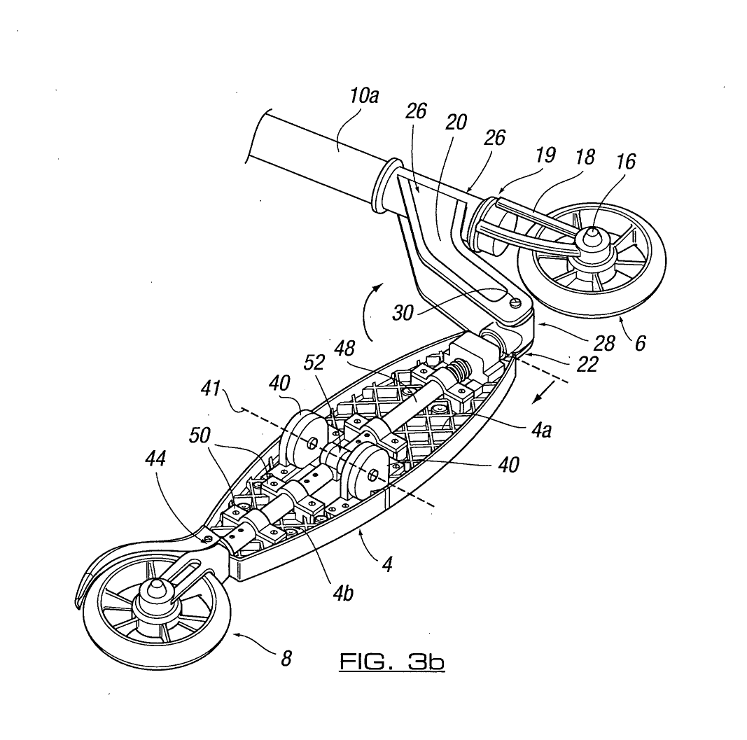

FIGS. 3a and 3b illustrate detailed views of a base surface of a front of the scooter in an erect and partially folded condition respectively;

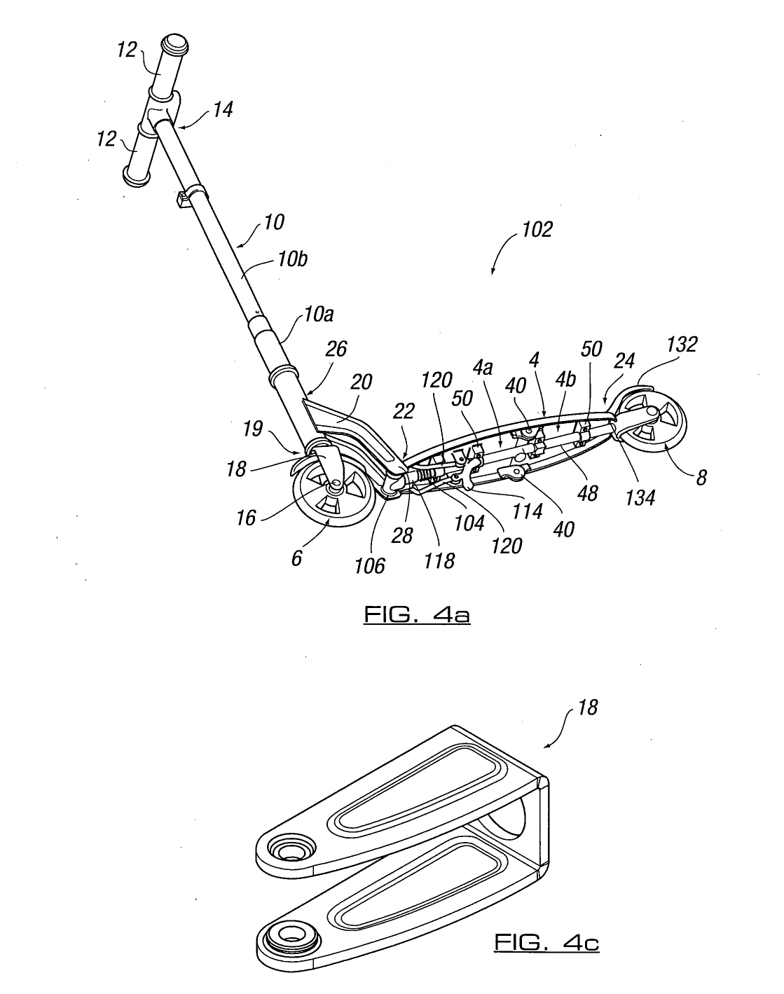

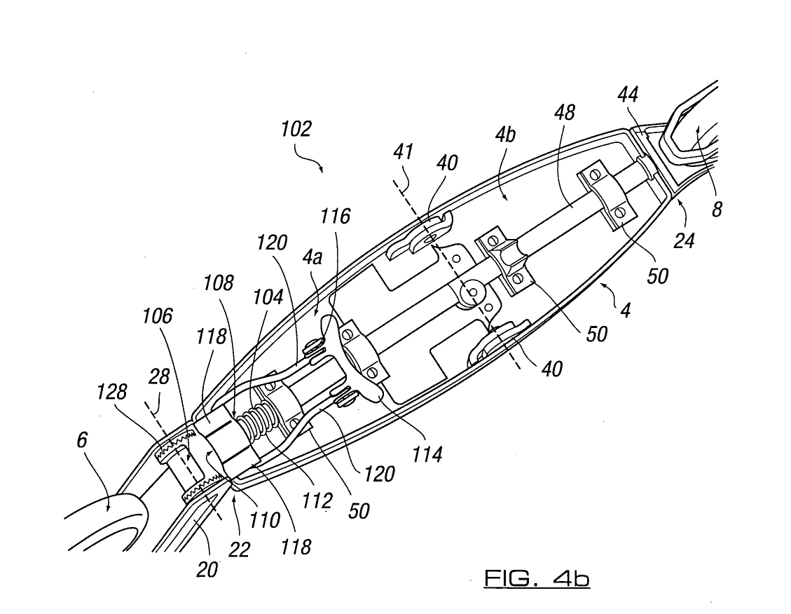

FIG. 4a shows a underside perspective view of a scooter according to a further embodiment of the present invention in an erect or first condition;

FIG. 4b shows an enlarged plan view of the underside of the scooter in FIG. 4a;

FIG. 4c shows an enlarged view of a front or rear fork of the scooter in FIGS. 4a-4b;

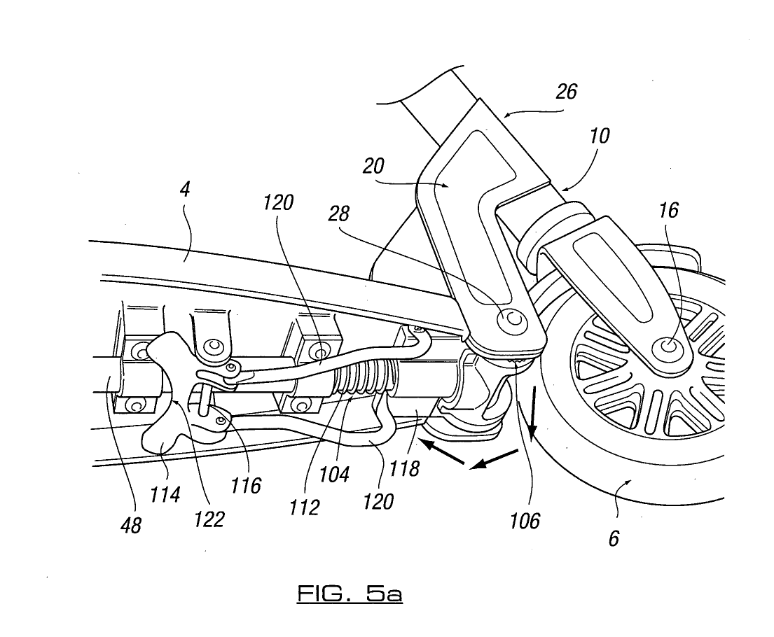

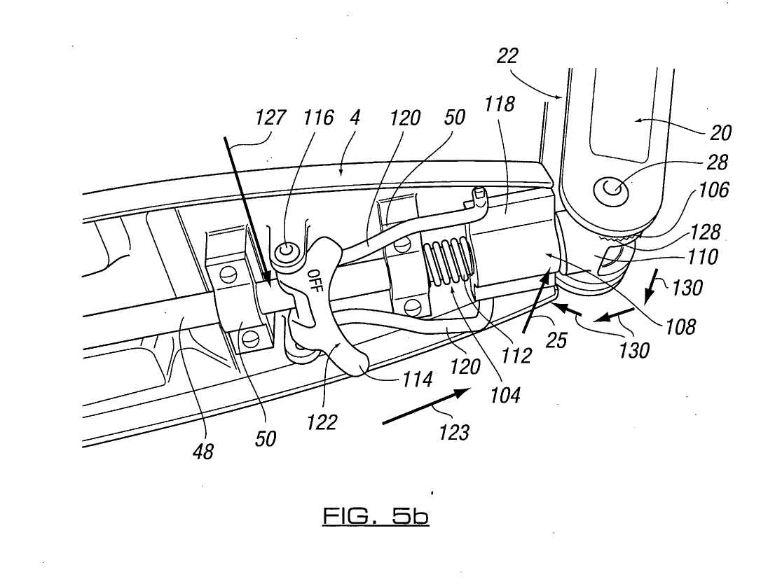

FIG. 5a shows an enlarged view of the connection between the handle means and the support means in the embodiment shown in FIGS. 4a-4c in a locked position; and

FIG. 5b shows an enlarged view of the connection in FIG. 5a being moved to an unlocked position.

Referring to the FIGS. 1a-3b, there is illustrated a manually driven toy scooter 2 comprising a plurality of components including support means in the form of an elongate foot plate 4, movement means in the form of front and rear wheels 6, 8 and handle means in the form of an upright steering column 10 with gripping portions 12 at both sides of the top 14 of said column 10.

Front wheel 6 has a substantially central rotational axle 16 which allows rotation of wheel 6 about a substantially horizontal axis in use. Connection means 18 are provided to join axle 16 to a base 19 of column 10, as shown in detail in FIG. 3b. More particularly, in the illustrated embodiment, connection means 18 is typically in the form of a plate or arm member located around a part of an exterior of wheel 6 which joins axle 16 to column 10. As such, rotation of column 10 about an upright axis or an axis substantially parallel to the longitudinal axis of column 10, changes the position of wheel 6, thereby allowing the scooter to be steered in use.

A further connection member 20 joins column 10 to a front end 22 of foot plate 4.

Rear wheel 8 is joined to a rear end 24 of foot plate 4. Rear wheel 8 is substantially similar in form to front wheel 6 and has a substantially central rotational axle 16 which allows rotation of wheel 8 about a substantially horizontal axis in use. Thus, front and rear wheels 6, 8 provide two points of contact with a ground surface at the front and rear ends of the foot plate on which the scooter is used to allow a user to balance the scooter in use.

The foot plate 4 is typically elongate in form but can be of any suitable size and/or shape to allow a user to locate at least one foot thereon in use to support the user.

Upright column 10 is typically elongate in form and two gripping portions 12 are provided at top 14 of column either side thereof and arranged substantially perpendicular thereto.

The longitudinal axis of connection member 20 in the erect or in-use position is typically substantially parallel to the longitudinal axis of column 10 and at an acute angle or substantially perpendicular to foot plate 4. In this position, connection member 20 is typically fixedly joined, to column 10 at end 26 thereof but pivotably joined to foot plate 4 via pivot joint 28, thereby allowing column 10 to rotate or pivot about a substantially upright or vertical axis 25 relative to foot plate 4. The substantially upright or vertical axis is typically substantially parallel to the longitudinal axis of column 10.

In FIGS. 3a and 3b, connection member 20 and connection member 18 are integrally formed but can be separate as in FIGS. 1a-1e and 2a-2e.

In accordance with the present invention, scooter 2 is movable between a first substantially erect position, as shown in FIGS. 1a and 2a, to a substantially folded position, as shown in FIGS. 1e and 2e. Intermediate folded positions of the scooter are shown in FIGS. 1b-1d and 2b-2d. The folding nature of the scooter is achieved by the components being arranged to move relative to other components and/or one or more parts of a component being arranged to move relative to one or more other parts of the component. Locking means are provided to maintain the component or component parts in a required position when the scooter is erect or folded. The locking means are movable between a locked position, wherein a required position of a component or component part can be maintained, to an unlocked position, wherein a component or component part can be moved.

More particularly, in addition to connection member 20 being pivotable about a substantially vertical or upright axis 25, connection member is also arranged to pivot or rotate about a substantially horizontal axis 27 (or an axis substantially parallel to the longitudinal axis of foot plate 4 as will be described in more detail below), thereby allowing column 10 to be moved from a substantially vertical position to a position at an acute angle relative to said vertical and/or substantially perpendicular thereto, as shown in FIG. 1b and FIG. 3b. In order to move connection member 20 about axis 27, locking means (described in more detail below) need to be moved from a locked position to an unlocked position. When column 10 is moved from a substantially upright position to a substantially horizontal position, pivot joint 30 provided on connection member 20 adjacent joint 28 is moved from a substantially horizontal position to a substantially vertical position, as shown in FIGS. 1a and 1b. Column 10 can then be pivoted about joint 28 from a position in FIG. 1b, wherein column 10 is substantially perpendicular to foot plate 4, to the position in FIG. 1c, wherein column 10 is substantially parallel to the longitudinal axis of foot plate 4, as shown by arrow 32.

Column 10 comprises two parts; an upper part 10b and a lower part 10c, together with a cover part 10a located over part of upper part 10b. Part 10a is of slightly larger dimensions that part 10b, thereby allowing cover part 10a to slidably move over part 10b. An outwardly resiliently biased pin (not shown) can be provided on part 10b which locks into an aperture provided on cover part 10a to maintain parts 10a and 10b in a required position in use. On depression of the pin through the aperture, part 10a can be slidably moved along the length of part 10b.

Column part 10c is joined to part 10b via hinge joint 34 and can be moved between an unfolded or erect position, wherein parts 10b, 10c are substantially co-axial with each other, to a folded position, wherein part 10b is moved through approximately 180 degrees so that the longitudinal axis of parts 10b, 10c are substantially parallel and adjacent to each other, as shown by arrow 36 in FIGS. 1d and 2d. Cover part 10a prevents folding about hinge joint 34 when located over the hinge 34, thereby locking the column in the erect position. Cover part is typically in the form of a cylindrical sleeve in the illustrations and is slidably moved a spaced distance apart from hinge 34 to allow parts 10b, 10c to pivot about hinge 34. In one embodiment, hinge joint 34 is a double hinge joint (i.e. two spaced apart hinges joined by a central link element, as shown in FIG. 2d. One hinge is joined to part 10b and one hinge is joined to part 10c). The cover part 10a when located over hinge 34 provides rigidity to the joint.

Gripping portions 12 are each joined to column 10 via hinge joints 38 and are movable between an erect position, wherein gripping portions 12 are co-axial with each other to form a T-junction with column 10 as shown in FIG. 1a-1c and 2a-2c, to a folded position, wherein gripping portions 12 are moved to be substantially parallel and adjacent to each other, as shown in FIGS. 1d-1e and 2d-2e.

The foot plate 4 typically comprises at least two parts; a front part 4a and a rear part 4b. The parts 4a and 4b are hingedly mounted together to allow folding of the parts about hinges 40 having an axis of rotation 41 substantially transverse to the longitudinal axis of the erect foot plate. As such, foot plate 4 can be moved from an erect position, wherein parts 4a and 4b are co-planar to form an elongate continuous foot plate, as shown in figures and 2a-2d, to a folded position, wherein parts 4a and 4b are substantially parallel and adjacent to each other, as shown by arrow 42 in FIGS. 1e and 2e. In this position, foot plate parts 4a and 4b are substantially parallel to column parts 10a, 10b, 10c. Hinges 40 are typically provided substantially centrally of foot plate 4 to provide two substantially equal foot plate parts 4a, 4b. However, the hinge 40 could be provided in any suitable location as required and foot plate 4 can include more than two parts and/or the parts can be of different lengths and/or sizes. In addition, a hinge 40 is provided either side of pivot arm 48.

Wheel 8 is typically pivotable relative to foot plate 4 via a pivot joint 44 which allows rotation of wheel 8 around an axis 46, as shown in FIG. 1b, which is substantially parallel to the longitudinal axis of the foot plate. This pivoting allows the wheel 8 to be moved from an erect position, wherein it is substantially perpendicular to the foot plate as shown in FIGS. 1a,2a, to a folded position, wherein it is substantially co-planar with foot plate 4, as shown in FIGS. 1b-1d, 2b-2d.

It can be seen in the figures that pivot joints 28, 44 provided at each end of the foot plate form part of the same pivotal arm 48 in one embodiment, as shown in FIGS. 2a-2d. This pivotal arm 48 is joined to the base of foot plate 4 and is freely rotatable within attachment brackets 50. As such, wheels 6, 8 can be rotated about the longitudinal axis of pivot arm 48 substantially simultaneously between the erect and folded positions. (Since pivot arm 48 is joined to connection member 20, rotation of pivot arm 48 causes the connection member 20, column 10 and wheel 6 to rotate).

Pivot arm 48 is provided with a locking member 52 adjacent hinge 40. With the wheels 6, 8 in an erect position, the locking arm prevents rotation of the foot plate parts around hinges 40, thereby maintaining the foot plate in an erect position. This is because the axis of rotation 54 of locking member 52 is substantially perpendicular to the axis of rotation 41 of hinges 40 and rotation of hinges 40 is therefore prevented. With the wheels 6, 8 in the folded or out of use position, the locking member 52 is rotated through approximately 90 degrees so that the axis of rotation 54 of locking member 52 is now substantially parallel to the axis of rotation 41 of hinges 40. As such, hinges 40 can now rotate about axis 41 and the foot plate parts can be moved about hinge 40 to fold the same.

When in the fully collapsed condition, the scooter can be located in a container, such as a bag or box, or can be carried on its own, to allow the scooter to be easily transported and/or stored. In the folded condition, the scooter is typically at least half the size of the scooter in the erect condition.

The scooter can be provided in any suitable shape, size and/or design and can be formed from any or any combination of suitable material, such as metal, wood, plastic, rubber and/or the like.

Referring to FIGS. 4a-5b, there is illustrated a further embodiment of the present invention showing a foldable scooter 102. The same reference numerals are used in these figures to show the same features as described in the earlier embodiments.

In this embodiment, the joint 28 via which the connection member 20 can be moved relative to foot plate 4 through both or either the upright axis 25 or horizontal axis 27 comprises a resiliently biased rotation pin 104 and a clutched safety axle 106.

The pivot arm 48 pivotably attached to the base of the foot plate has a rotation pin 104 provided at end 22 of the foot plate.

The free end 108 of pin 104 is locatable in a complementary socket 110 provided on connection member 20 in a locked position and removable therefrom in an unlocked position. Resilient biasing means in the form of a spring 112 is provided over pin 104 to bias the same to the locked position.

With pin 104 in the locked position, rotation of foot plate 4 relative to connection member 20 is prevented.

User actuation means in the form of a rotatable handle 114 is provided for movement of pin 104 between the locked and unlocked positions. A pivot pin 116 is provided substantially transversely of the base of foot plate 4 and handle 114 is rotatable about said pin in moving between the locked and unlocked positions.

Handle 114 is joined to a plate 118 associated with the free end of pin 108 via linkage arms 120 provided either side of pin 108. As handle is moved from the locked position to the unlocked position, this causes a rear edge 122 to move from a direction facing rear wheel 8 to a direction facing front wheel 6, as shown by arrow 123. In turn, this causes the linkage arms 120 and plate 118 to move towards rear wheel 8, thereby compressing spring 112 and causing pin 104 to move from the locked position to the unlocked position, as shown by arrow 125.

With the pin 104 released from the socket in connection member 20, the connection member can be moved relative to foot plate 4 as previously described in the earlier described embodiment.

In addition, as pin 104 is released from connection member 20 this causes pivot arm 48 to move rearwardly of the foot plate or draw tension from arm 48, thereby allowing release of the locking mechanism 52 associated with the hinged parts 4a and 4b, as shown by arrow 127. The foot plate can then be moved from an erect to a folded condition.

Clutched safety axle 106 is provided to ensure that movement of connection member 20 relative to foot plate 4 between the folded and erect conditions takes place in a controlled manner, thereby preventing a user from trapping their fingers in the mechanism and injuring themselves.

More particularly, the clutched safety axle includes a toothed or geared wheel or rotation portion 128 either end thereof around which connection member 20 rotates, as shown by arrows 130.

The guard 132 covering rear wheel 8 can be pivotably mounted via pivot 134 to foot plate 4 to act as a brake for the scooter. The guard can be resiliently biased to an upwardly position wherein the guard is clear of wheel 8. When a user places their foot on top of the guard 132, this moves the interior surface of guard 132, either directly or indirectly, into contact with the wheel, thereby causing a braking affect on wheel 8.

1. A scooter, said scooter comprising a plurality of components including at least support means for supporting at least part of a user thereon in use, scooter movement means associated with said support means for allowing the support means to move across a surface in use and handle means for allowing a user to hold onto the scooter in use, and wherein one or more of said components are provided with means to allow the component or a part of said component to move relative to another component or other part of said component between a first substantially erect condition and at least a second partially or substantially folded or collapsed condition, characterised in that a pivotable or rotatable arm is provided substantially along the length of the support means and joins, either directly or indirectly, the scooter movement means and/or handle means provided at a front and/or rear of the scooter.

2.-15. (canceled)

16. A scooter according to claim 1 characterised in that the scooter movement means and handle means are joined by connection or linkage means and are arranged such that movement of the scooter movement means between first and second conditions automatically moves or allows movement of the handle means between first and second conditions.

17. A scooter according to claim 1 characterised in that the handle means are pivotable or rotatable about a substantially horizontal axis or an axis substantially parallel to the longitudinal axis of the support means in moving between the first and second conditions.

18.-22. (canceled)

23. A scooter according to claim 1 characterised in that the support means includes two or more parts and said parts are movable between a first condition, wherein the support mean parts are substantially co-planar to form an elongate platform, and a second condition, wherein at least one of the support mean parts is moved through approximately 180 degrees so the parts are substantially adjacent and parallel to each other.

24.-26. (canceled)

27. A scooter according to claim 1 characterised in that the pivotable or rotatable arm is provided adjacent a base of the support means and is joined to the same via attachment means which allow free rotation of the arm therein.

28. A scooter according to claim 23 characterised in that the two or more parts of the support means are hingedly mounted together via hinge means, a locking mechanism is provided with the pivotable or rotatable arm and is arranged so that with the scooter in the first condition, the axis of rotation of the locking mechanism is substantially perpendicular to an axis of rotation of the hinge means of the support mean parts, and when the scooter movement means have been moved to a second condition, this moves the locking mechanism so that the axis of rotation of the locking mechanism is substantially parallel to the axis of rotation of the hinge means, thereby allowing the support means to be moved to the second condition.

29. A scooter according to claim 28 characterised in that the locking mechanism used to maintain the support means in a first condition is resiliently biased to a locked position.

30. (canceled)

31. A scooter according to claim 1 characterised in that the rotatable or pivotable arm of the support means is associated with a pin, said pin movable between a locked position, wherein said pin engages in a complementary socket provided on connection means associated with the handle means and/or scooter movement means, to an unlocked position, wherein the pin is moved out of engagement with the connection means socket, thereby allowing rotation of the connection means relative to the support means.

32. A scooter according to claim 31 characterised in that the pin is resiliently biased to the locked position.

33. A scooter according to claim 31 characterised in that the connection means has a clutched axle, toothed rotatable member and/or gear mechanism to allow controlled movement of the connection means relative to the support means in the unlocked position.

34. A scooter according to claim 31 characterised in that user actuation means are associated with the pin to allow said pin to be moved between the locked and unlocked positions.

35. A scooter according to claim 34 characterised in that the user actuation means are joined to a movable plate member via linkage arms and movement of the user actuation means causes movement of the movable plate member which in turn moves the pin.

36. A method of using a scooter, said scooter comprising a plurality of components including at least support means for supporting at least part of a user thereon in use, scooter movement means associated with said support means for allowing the support means to move across a surface in use and handle means for allowing a user to hold onto the scooter in use, and wherein said method includes the step of moving one or more of said components or a part of said component relative to another component or other part of said component between a first substantially erect condition and at least a second partially or substantially folded or collapsed condition, characterised in that a pivotable or rotatable arm is provided substantially along the length of the support means and joins, either directly or indirectly, the scooter movement means and/or handle means provided at a front and/or rear of the scooter.

37. A scooter according to claim 1 characterised in that the pivotable or rotatable arm is provided substantially parallel to a longitudinal axis of the support means and said pivotable or rotatable arm is able to pivot or rotate about an axis substantially parallel to the longitudinal axis of the support means.

38. A scooter according to claim 1 characterised in that pivotal joints are provided at each end of the support means and form part of the pivotable or rotatable arm, the pivotal joints arranged to allow pivoting of the scooter movement means about an axis substantially parallel to the longitudinal axis of the support means.
